(19) United States
(12) Patent Application Publication
(10) Pub. No.: US 2014/0272842 A1
(43) Pub. Date: Sep. 18, 2014

(54) ASSESSING COGNITIVE ABILITY

(71) Applicant: Predinex UG (haftungsbeschränkt), Mulheim an der Ruhr (DE)

(72) Inventor: Sebastian Edward Kwiatkowski, Mulheim an der Ruhr (DE)

(21) Appl. No.: 13/843,769

(22) Filed: Mar. 15, 2013

(51) Int. Cl. G09B 19/00

(52) U.S. Cl. CPC G09B 19/00
USPC 434/236

(57) ABSTRACT

The subject matter of this specification can be implemented in, among other things, a method that includes receiving first cognitive ability levels for first persons. The first cognitive ability levels represent assessments of the first persons within a model of cognitive abilities. The method further includes receiving first user generated online data of the first persons. The method further includes extracting first values for one or more types of features from the first user generated online data. The method further includes comparing, by a processing device, the extracted first values to the received first cognitive ability levels to identify relationships between the types of features and the received first cognitive ability levels. The method further includes storing the relationships between the types of features and the received first cognitive ability levels in a storage device.

### TECHNICAL FIELD

This instant specification relates to assessing cognitive ability.

### BACKGROUND

An intelligence quotient (IQ) score is often used to estimate a person's general intelligence or general (g) factor. The g factor is a variable that summarizes positive correlations among different cognitive tasks. This may reflect that the person's performance at one type of cognitive task tends to be comparable to his or her performance at other kinds of cognitive tasks. The terms IQ, general intelligence, general cognitive ability, general mental ability, or intelligence are often used interchangeably to refer to the common core shared by cognitive tests.

Today, models of intelligence, such as the Cattell-Horn-Carroll (CHC) theory, typically represent cognitive abilities as a three-level hierarchy. The bottom level of the hierarchy includes a large number of narrow factors. The intermediate level of the hierarchy includes a handful of broad, more general factors. The apex of the hierarchy generally includes a single factor, referred to as the g factor, which represents the variance common to all cognitive tasks.

### SUMMARY

In one aspect, a method includes receiving first cognitive ability levels for first persons. The first cognitive ability levels represent assessments of the first persons within a model of cognitive abilities. The method further includes receiving first user generated online data of the first persons. The method further includes extracting first values for one or more types of features from the first user generated online data. The method further includes comparing, by a processing device, the extracted first values to the received first cognitive ability levels to identify relationships between the types of features and the received first cognitive ability levels. The method further includes storing the relationships between the types of features and the received first cognitive ability levels in a storage device.

Implementations can include any, all, or none of the following features. The method can include receiving second user generated online data of second persons. The method can further include extracting second values for the types of features from the second user generated online data. The method can further include applying the stored relationships to the second values to assess second cognitive ability levels of the second persons within the model of cognitive abilities. One or more of the first persons or the second persons can be users of social networking, blogging, Internet chats, or discussion board systems. One or more of the first user generated online data or the second user generated online data can be posts to the social networking, blogging, Internet chats, or discussion board systems. The method can include determining that a first set of the first persons is associated with a second set of the second persons. Applying the stored relationships can include applying a relationship among the stored relationships for the first set to the second set as a group. The types of features can include a measure of words used within multiple groups of words for each of the first persons and the second persons. The types of features can include one or more of a measure of vocabulary size for each of the first persons and the second persons, or a measure of a comparison between the vocabulary size for each of the first persons and the second persons to an average vocabulary size of other persons. The types of features can include one or more of a measure of words used from particular subject matter topics for each of the first persons and the second persons, or a measure of a range of subject matter topics for each of the first persons and the second persons. The types of features can include a measure of uncommon words used that are also included in documents that are linked to by the first user generated online data or the second user generated online data. The first cognitive ability levels can include results of an intelligence test. The method can further include performing the intelligence test on one or more of the first persons to generate one or more of the first cognitive ability levels. Receiving the first cognitive ability levels can include receiving third user generated online data that can include one or more of the first cognitive ability levels for one or more of the first persons. The method can include receiving associations between one or more of the first persons and one or more organizations. Receiving the first cognitive ability levels can include identifying one or more of the first cognitive ability levels based on the associations.

In one aspect, a non-transitory computer-readable medium having instructions stored thereon, which when executed by a processing device, cause the processing device to perform operations that include receiving first cognitive ability levels for first persons. The first cognitive ability levels represent assessments of the first persons within a model of cognitive abilities. The operations further include receiving first user generated online data of the first persons. The operations further include extracting first values for one or more types of features from the first user generated online data. The operations further include comparing, by the processing device, the extracted first values to the received first cognitive ability levels to identify relationships between the types of features and the received first cognitive ability levels. The operations further include storing the relationships between the types of features and the received first cognitive ability levels in a storage device.

Implementations can include any, all, or none of the following features. The operations can further include receiving second user generated online data of second persons. The operations can further include extracting second values for the types of features from the second user generated online data. The operations can further include applying the stored relationships to the second values to assess second cognitive ability levels of the second persons within the model of cognitive abilities. One or more of the first persons or the second persons can be users of social networking, blogging, Internet chats, or discussion board systems. One or more of the first user generated online data or the second user generated online data can be posts to the social networking, blogging, Internet chats, or discussion board systems. The operations can further include determining that a first set of the first persons is associated with a second set of the second persons. Applying the stored relationships can include applying a relationship among the stored relationships for the first set to the second set as a group. The types of features can include a measure of words used within multiple groups of words for each of the first persons and the second persons. The types of features can include one or more of a measure of vocabulary size for each of the first persons and the second persons, or a measure of a comparison between the vocabulary size for each of the first persons and the second persons to an average vocabulary size of other persons. The types of features can include one or more of a measure of words used from particular subject matter topics for each of the first persons and the second persons, or a measure of a range of subject matter topics for each of the first persons and the second persons. The types of features can include a measure of uncommon words used that are also included in documents that are linked to by the first user generated online data or the second user generated online data. The first cognitive ability levels can include results of an intelligence test. The operations can further include performing the intelligence test on one or more of the first persons to generate one or more of the first cognitive ability levels. Receiving the first cognitive ability levels can include receiving third user generated online data that can include one or more of the first cognitive ability levels for one or more of the first persons. The operations can further include receiving associations between one or more of the first persons and one or more organizations. Receiving the first cognitive ability levels can include identifying one or more of the first cognitive ability levels based on the associations.

In one aspect, a system includes one or more interfaces to receive first cognitive ability levels and first user generated online data for first persons. The first cognitive ability levels represent assessments of the first persons within a model of cognitive abilities. The system further includes one or more processing devices to extract first values for one or more types of features from the first user generated online data, compare the extracted first values to the received first cognitive ability levels to identify relationships between the types of features and the received first cognitive ability levels. The system further includes one or more storage devices to store the relationships between the types of features and the received first cognitive ability levels.

Implementations can include any, all, or none of the following features. The interfaces can be further to receive second user generated online data of second persons. The processing devices can be further to extract second values for the types of features from the second user generated online data and apply the stored relationships to the second values to assess second cognitive ability levels of the second persons within the model of cognitive abilities. One or more of the first persons or the second persons can be users of social networking, blogging, Internet chats, or discussion board systems. One or more of the first user generated online data or the second user generated online data can be posts to the social networking, blogging, Internet chats, or discussion board systems. The processing devices can be further to determine that a first set of the first persons can be associated with a second set of the second persons, and apply a relationship among the stored relationships for the first set to the second set as a group. The types of features can include a measure of words used within multiple groups of words for each of the first persons and the second persons. The types of features can include one or more of a measure of vocabulary size for each of the first persons and the second persons, or a measure of a comparison between the vocabulary size for each of the first persons and the second persons to an average vocabulary size of other persons. The types of features can include one or more of a measure of words used from particular subject matter topics for each of the first persons and the second persons, or a measure of a range of subject matter topics for each of the first persons and the second persons. The types of features can include a measure of uncommon words used that are also included in documents that are linked to by the first user generated online data or the second user generated online data. The first cognitive ability levels can include results of an intelligence test. The processing devices can be further to perform the intelligence test on one or more of the first persons to generate one or more of the first cognitive ability levels. The interfaces can be further to receive third user generated online data that can include one or more of the first cognitive ability levels for one or more of the first persons. The interfaces can be further to receive associations between one or more of the first persons and one or more organizations. The processing devices can be further to identify one or more of the first cognitive ability levels based on the associations.

The details of one or more implementations are set forth in the accompanying drawings and the description below. Other features and advantages will be apparent from the description and drawings, and from the claims.

### DESCRIPTION OF DRAWINGS

FIG. 1 is a schematic diagram that shows an example of a system for assessing cognitive ability.

FIG. 2 is a block diagram that shows an example of an assessment system for assessing cognitive ability.

FIG. 3 is flow chart that shows an example of a process for assessing cognitive ability.

FIG. 4 is a schematic diagram that shows an example of a computing system.

### DETAILED DESCRIPTION

This document describes systems and techniques for assessing cognitive ability. The system extracts values for features within user generated online data from an initial set of users, such as posts to a social network, posts to a blog, comments on a discussion board, or other user generated online data. The users in the initial set have associated cognitive ability levels. The cognitive ability levels represent one or more categories of cognitive ability and/or a general factor of cognitive ability. The system compares the extracted values with the cognitive ability levels to identify relationships between the features and the cognitive ability levels. The system then extracts values for the features within user generated online data for another set of users. The system applies the relationships to the values for the users in the other set to assess the cognitive ability levels of the other users.

The systems and techniques described here may provide one or more of the following advantages. For example, the systems and techniques may provide for identifying cognitive ability levels for one set of individuals based on cognitive ability levels for another set of individuals and user generated online data for the other set of individuals. The systems and techniques may provide for identifying cognitive ability levels for one set of individuals based on cognitive ability levels for another set of individuals and user generated online data for the other set of individuals without performing intelligence testing for either set of individuals.

FIG. 1 is a schematic diagram that shows an example of a system 100 for assessing cognitive ability. The system 100 includes one or more first client computing devices 102a-c in communication with at least one first server system 104a over at least one network 106, such as a local computing network, a wide computing network, and/or one or more of the computing devices that make up the Internet. The first client computing devices 102a-c may also be in communication with an assessment system 108. One or more first persons 110a-c at corresponding ones of the first client computing devices 102a-c each send one or more first user generated online data 112 to the first server system 104a. For example, the first user generated online data 112 may include media such as text, images, audio, video, and/or metadata (e.g., information describing other media and/or hyperlinks to other media). The first client computing devices 102a-c upload the media to the first server system 104, for example, as posts or comments to a social network, a blog, a discussion board, a microblog, Internet chat, and/or a newsgroup.

Each of the first user generated online data 112 is associated with a particular user account within the first server system 104a for corresponding ones of the first persons 110a-c. For example, the first server system 104a may include media from the first user generated online data 112 for each of the first persons 110a-c on a particular profile page, web page, web feed, and/or data feed for the person's user account. The first server system 104 makes the person's media from the first user generated online data 112 available to other systems, such as the assessment system 108. The assessment system 108 may then send requests to the first server system 104a for the first user generated online data 112 and/or the pages/feeds that include the first user generated online data 112.

The assessment system 108 then extracts features from the first user generated online data 112. For example, the assessment system 108 may extract features from the first user generated online data 112 for each of the first persons 110a-c that include particular words and/or phrases, such as “think,” “read,” “hypothesis,” or “scientific method.” The assessment system 108 may perform optical character recognition on images and/or video media to identify words within the images and/or video. The assessment system 108 may also perform speech recognition on the audio and/or video media to identify words within the audio and/or video. In some implementations, the assessment system 108 may retrieve metadata from the first server system 104a for the audio and/or video media that includes a transcript of words spoken in the audio and/or video media.

The assessment system 108 may score the extracted words. For example, the assessment system 108 may score three values for each of the extracted words. First, the assessment system 108 may assign a score to each word for the frequency with which others generally use the word. For example, the assessment system 108 may look up each word and/or phrase in a list of word frequencies (e.g., the word “patent” is used less frequently than the word “document” and, accordingly, “patent” receives a higher score than “document”). Second, the assessment system 108 may assign a score to each words and/or phrase for an accuracy and/or response time for a lexical decision task represented by the word and/or phrase. Third, the assessment system 108 may assign a score to each words and/or phrase for an accuracy and/or response time for naming task represented by the word and/or phrase. For example, the assessment system 108 can look up each word and/or phrase in a lexicon for the particular language to retrieve the associated accuracy and/or response time scores for the lexical decision task and naming task. The scores represent measurements of each feature.

The assessment system 108 may extract the words as raw words from the first user generated online data 112, e.g., for use in extracting other features. The assessment system 108 may also reduce raw words from the first user generated online data 112 to corresponding lemmas of the raw words and include the lemmas in the words used to extract other features. In addition, the assessment system 108 may identify stems of the raw words from the first user generated online data 112. The assessment system 108 may include the stems in the words used to extract other features. The assessment system 108 may also identify other words that have the identified stems and include the other words in the words used to extract other features. The features may also include the number of posts for each person, the average length of posts for each person, and usage frequency of different languages for each person.

As an example of other features, the assessment system 108 may extract a size of a person's vocabulary from the first user generated online data 112 for the person. The assessment system 108 may extract a measure of the person's spelling accuracy within the first user generated online data 112 for the person. The assessment system 108 may extract subject matter topics discussed from the first user generated online data 112 for the person (e.g., politics, sports, art, finance, and/or science). The assessment system 108 may extract a range of subject matter topics discussed from the first user generated online data 112 for the person (e.g., a number of different topics and/or frequency of posts within each topic). The assessment system 108 may extract types of music discussed from the first user generated online data 112 for the person (e.g., classical music, popular music, and/or jazz music). The assessment system 108 may extract frequencies with which the types of music are discussed.

The assessment system 108 may extract frequencies with which words are used from the first user generated online data 112 for the person. The words used may belong to groups that have been identified as psychometrically relevant groups. For example, the words “argue,” “think,” and “reason” may be identified as belonging to a group that includes words related to cognition. The assessment system 108 may use the frequency of usage of words within a group (e.g., the frequency with which “argue,” “think,” and “reason” are used by the person) as a feature of the first user generated online data 112 for the person.

The assessment system 108 may extract usage of humor and/or metaphors from the first user generated online data 112 for the person. For example, the assessment system 108 may identify particular words and/or phrases in the first user generated online data 112 for the person that are associated with humor and/or metaphors. The assessment system 108 may identify particular metadata in the first user generated online data 112 for the person that are associated with humor and/or metaphors (e.g., hashtags, such as “#ironic” and/or “#funny”). The assessment system 108 may identify particular words and/or phrases in the first user generated online data 112 for another person that indicate the first person is using humor and/or metaphors (e.g., a comment, such as “lol”).

The assessment system 108 may extract information about hyperlinks to other content. For example, the assessment system 108 may determine that a post in the first user generated online data 112 for the person includes a link to other content, such as a hyperlink to an article on another website. The assessment system 108 may access the article to identify words in the post that are not commonly used that also appear in the article. The feature can include a measure of uncommon words used from the article, such as a total number of words, number of different words, and/or a number of words scaled based on the size of the post and/or article.

The assessment system 108 may also extract one or more of the features described from other types of data, such as a person's browsing history and/or bookmarks. The assessment system 108 may solicit the person for permission to use the content of the person's browsing history and/or bookmarks. In some implementations, the person's browsing history and/or bookmarks may be accessed from one or more of the first client computing devices 102a-c and/or the first server system 104a. For example, a client computing device may have an application that sends the person's browsing history and/or bookmarks to the assessment system 108. In another example, the person may provide the assessment system 108 with access to the person's browsing history and/or bookmarks at the first server system 104a.

The assessment system 108 may extract geolocation information for the first client computing devices 102a-c from the network addresses (e.g., Internet Protocol addresses) and postal addresses of the first persons 110a-c mentioned in the first user generated online data 112. The assessment system 108 may look up the postal address and/or geographic location of the first persons 110a-c using the network addresses.

In addition to extracting features, the assessment system 108 also receives one or more cognitive ability levels 114 for each of the first persons 110a-c. The cognitive ability levels 114 may be measures of performance for tasks from a model of cognitive abilities, such as the Cattell-Horn-Carroll (CHC) theory of cognitive ability or a variation on the CHC theory. The cognitive tasks may include, for example, a measure of a person's ability to update information stored in the person's short term memory and the person's ability to inhibit irrelevant information. This is sometimes referred to as a person's “working memory.” The cognitive tasks may also include other tasks from the model of cognitive abilities.

In some implementations, the first client computing devices 102a-c may provide information regarding the cognitive ability levels 114 directly to the assessment system 108. For example, the assessment system 108 may provide questions to answer and/or tasks to complete to one or more of the first client computing devices 102a-c. The first client computing devices 102a-c then provide answers to the questions and information regarding completion of the tasks to the assessment system 108. The assessment system 108 then scores the answers and completion information to assess the cognitive ability levels 114 of the first persons 110a-c.

In some implementations, the assessment system 108 may identify the cognitive ability levels 114 of one or more of the first persons 110a-c indirectly. For example, the first persons 110a-c may post their respective ones of the cognitive ability levels 114 to the first server system 104a (e.g., in additional user generated online data for the first persons 110a-c). The assessment system 108 may then retrieve the posts from the first server system 104a and analyze the posts to identify the cognitive ability levels 114. The assessment system 108 may analyze a post to find context within text, audio, or images indicating that the post includes a cognitive ability level, such as “My IQ is 129,” “My g factor is 131,” “My fluid intelligence is 145,” and/or “My Gf is 142.” The assessment system 108 may also analyze metadata in a post for an indication that the post includes a cognitive ability level, such as an intelligence testing service that inserts a particular hashtag into posts that include a cognitive ability level (e.g., “I scored 135 #IntelligenceTestingService”).

In some implementations, the assessment system 108 may estimate one or more of the cognitive ability levels 114. For example, the assessment system 108 may determine from the extracted features that a person is member of or follows a particular group, such as a society of individuals with high general intelligence scores. The assessment system 108 may assign a particular cognitive ability level to the person, such as a reported average cognitive ability level of the group. In another example, the assessment system 108 may assign a particular cognitive ability level to the person that is a particular number of standard deviations above a mean for the cognitive ability level of persons who do not belong to the group.

While general intelligence (g) factor and fluid intelligence (Gf) are examples of high level measures of cognitive ability levels, lower level measures of cognitive ability levels may be used. For example, the cognitive ability levels 114 may include measures of the person's ability to perform inductive reasoning, ability to perform sequential reasoning, ability to perform quantitative reasoning, memory span, and/or working memory capacity.

Next, the assessment system 108 compares the cognitive ability levels 114 of the first persons 110a-c to the extracted features from the first user generated online data 112 of the first persons 110a-c. As part of the comparison, the assessment system 108 may apply a machine learning tool, such as a neural network, random forest, and/or support vector machine to identify relationships between the cognitive ability levels 114 and the extracted features. For example, the assessment system 108 may determine that there is a relationship between a particular threshold number of different subject matter topics discussed and high measures of a particular cognitive ability, such as fluid intelligence. The assessment system 108 then stores the identified relationships for later use in assessing cognitive ability levels of one or more second persons 116a-c.

The second persons 116a-c are associated with one or more second client computing devices 118a-c. The second client computing devices 118a-c are in communication with at least one second server system 104b over the network 106 or another network. The assessment system 108 is also in communication with the second server system 104b, such as over the network 106. The second persons 116a-c send one or more second user generated online data 120 to the second server system 104b. The assessment system 108 then receives the second user generated online data 120 from the second server system 104b, for example, in response to a request for the second user generated online data 120. The assessment system 108 may also receive the second user generated online data 120 from another system, such as from one or more of the second client computing device 118a-c.

The assessment system 108 performs the extraction of features from the second user generated online data 120. The assessment system 108 then applies the stored relationships to the features from the second user generated online data 120 to assess the cognitive ability levels of the second persons 116a-c. For example, if the assessment system 108 determines that a person has discussed the threshold number of different subject matter topics, then the assessment system 108 may assess the person as having the corresponding fluid intelligence cognitive ability level for that threshold.

The assessment system 108 may also estimate one or more cognitive ability levels for a group of persons, such as audiences and/or fans of particular websites and/or products. The assessment system 108 may assess the cognitive ability levels of the second persons 116a-c and also determine that the second persons 116a-c are, for example, all followers of a particular fan page on a social network or a particular account on a microblogging system. The assessment system 108 then calculates an average of the cognitive ability levels for the second persons 116a-c.

The assessment system 108 may then provide the second cognitive ability levels and/or the average cognitive ability levels of the second persons 116a-c to another system. For example, the assessment system 108 may provide the second cognitive ability levels to an employment system that uses the second cognitive ability levels to match the second persons 116a-c with corresponding prospective employers. The assessment system 108 may provide the second cognitive ability levels to an advertising system that matches the second cognitive ability levels to advertisements for businesses that correspond to the second cognitive ability levels and/or products that correspond to the second cognitive ability levels. The assessment system 108 may provide the second cognitive ability levels to financial institutions for use in assessing a credit risk for one of the second persons 116a-c. The assessment system 108 may provide the second cognitive ability levels to a service provider that uses the second cognitive ability levels to select a default setting from among multiple user settings, such as between a basic user interface and an advanced user interface. In another example, the assessment system 108 may provide the second cognitive ability levels to a system used by an insurance company. The insurance company system may then use the second cognitive ability levels to evaluate the corresponding person's health and/or mortality risk, e.g., high values for one or more of the second cognitive ability levels may indicate a low risk of health problems and/or mortality. In yet another example, the assessment system 108 may provide the average cognitive ability levels for a group of users of a website to a web analytics company.

FIG. 2 is a block diagram that shows an example of an assessment system 200 for assessing cognitive ability. The assessment system 200 includes one or more interfaces 202 for communicating with computing devices, such as the first client computing devices 102a-c and the second client computing devices 118a-c. The assessment system 200 includes an intelligence module 204 that provides one or more intelligence questions 206 to each of the first client computing devices 102a-c. The intelligence questions 206 instruct the first persons 110a-c to perform various cognitive tasks. Each of the first client computing devices 102a-c then provide one or more intelligence answers 208 to the intelligence module 204 that include the results of performing the cognitive tasks. The intelligence module 204 then calculates first cognitive ability levels for the first persons 110a-c and stores the first cognitive ability levels in a storage device 210.

The assessment system 200 includes a feature extraction module 212 that receives multiple first user generated online data 214 for each of the first persons 110a-c, e.g., from a server such as the first server system 104a. The feature extraction module 212 analyzes the first user generated online data 214 to extract first features from words in the first user generated online data 214, such as the types of features described with respect to FIG. 1. The feature extraction module 212 may store the first features in the storage device 210 or in another storage device.

The assessment system 200 includes a comparison module 216 that retrieves the first cognitive ability levels and the first features from the storage device 210. The comparison module 216 compares the first cognitive ability levels to the first features to identify relationships between the types of features and the cognitive ability levels. The comparison module 216 may use one or more ways to identify the relationships. For example, the comparison module 216 may use a random forest technique. The random forest technique includes an ensemble classifier. The ensemble classifier includes multiple decision trees (e.g., one hundred or two hundred trees) and outputs a class that is the mode of the classes output by the individual trees.

In another example, the comparison module 216 may use a support vector machine to identify the relationships between the first cognitive ability levels and the types of features. The support vector machine analyzes the first cognitive ability levels and the first features for the types of features to recognize patterns that are used for classification and regression analysis of the relationships. Given the set of training examples represented by the first cognitive ability levels and the first features, patterns between the first features and the first cognitive ability levels are used to mark the feature value as belonging to a particular class or value of cognitive ability level.

In yet another example, the comparison module 216 may use an artificial neural network, sometimes referred to as a neural network. The neural network includes an interconnected group of artificial neurons that represent the first features as inputs and the first cognitive levels as outputs. The neural network processes information using a connectionist approach to computation. The neural network is an adaptive system that changes its structure during a learning phase based on the first features and the first cognitive levels. The neural network models the relationships between the first feature inputs and the first cognitive ability level outputs to find patterns between them. Between the inputs and the outputs there are one or more hidden layers of artificial neuron nodes, such as three hidden layers.

In yet another example, the comparison module 216 may use ensemble learning to identify relationships between the features and the cognitive ability levels. For example, the comparison module 216 may sample a first subset of the data for the features. The comparison module 216 divides the first subset into a training set and a test set. The comparison module 216 trains a model using the training set. The comparison module 216 then applies the model to the test set and evaluates the results using an error function, such as a binary or squared error function (described below). The comparison module 216 then performs a second iteration with a different subset of the data for the features. The comparison module 216 may sample the different subset either randomly or with a view toward including those data points that were predicted incorrectly by the first model in the previous iteration. For example, where a data point for which a first model incorrectly assessed a cognitive ability level, the comparison module 216 may assign a greater chance of being included again in a subsequent partition so that a subsequent model can attempt to assess the cognitive ability level for the feature correctly. The comparison module 216 performs a particular number of iterations. The comparison module 216 may weight each of the models based on the errors associated with each model. For example, a high error may receive a low weight and a low error may receive a high weight.

The comparison module 216 may select a particular type of model based on a cross-validation or a variation of cross-validation. For example, the comparison module 216 may compare the results of the models to one another. The comparison module 216 may partition data for the first features and the first cognitive ability levels into a number of randomly sampled subsets (without replacement). In some implementations, the comparison module 216 uses a ten-fold cross-validation is used, which partitions the data into ten subsets (e.g., a dataset with one thousand data points would be partitioned into ten partitions each with one hundred data points).

The comparison module 216 performs a training session for each partition for each type of model (e.g., variations of one or more of the random forest, support vector machine, or neural network models). For a particular partition, the comparison module 216 trains each module with the data from the partitions other than the particular partition. The comparison module 216 uses the data from the particular partition to calculate an error using an error function, such as a squared error function and/or a binary error function.

In a simplified example, the comparison module 216 may train a particular model using a set of features and cognitive ability levels. The comparison module 216 may then apply the trained model to the excluded partition (e.g., two feature data points) to assess numerical cognitive ability levels, such as IQs of 117 and 125 for the two data points. The actual cognitive ability levels that correspond to the two feature data points may be IQs of 113 and 124, respectively. The comparison module 216 may then calculate the error for the numerical model using a squared error equation such as Equation 1.

$$\frac{{( 117 - 113 )}^{2} + {( 125 - 124 )}^{4}}{2} = 8.5 \qquad Equation 1$$

For models that make class predictions of cognitive ability levels, the comparison module 216 may use another error function, such as a binary error function. If a class of cognitive ability levels assessed by the comparison module 216 is equal to the actual class from the received cognitive ability levels, then the error from the binary function may be a first particular value, such as zero. If the class of cognitive ability levels assessed by the comparison module 216 is not equal to the received cognitive ability levels, then the error from the binary function may be a second particular value, such as one.

After the comparison module 216 has calculated errors for each of the models, the comparison module 216 may calculate the cross-validation error for each model by taking the average of the errors that were calculated for each partition for the model. The comparison module 216 may then select the model with the smallest cross-validation error as the model to be used to assess and/or predict cognitive ability levels for subsequently extracted features from other persons. The comparison module 216 stores the relationships between the types of features and the cognitive ability levels, which is represented by the selected model, in the storage device 210.

The assessment system 200 then receives multiple second user generated online data 218 for persons such as the second persons 116a-c from a system such as the second server system 104b. The feature extraction module 212 extracts second features from the second user generated online data 218. The feature extraction module 212 then provides the second features to an assessment module 220.

The assessment module 220 retrieves the relationships from the storage device 210, e.g., the model selected by the comparison module 216. The assessment module 220 applies the selected model to the second features to assess one or more second cognitive ability levels 222 of each of the second persons 116a-c. The second cognitive ability levels 222 may classify each of the second persons 16a-c as being within a particular range of cognitive ability levels. For example, given a set of classes of cognitive abilities, such as quintiles or groups defined by standard deviations (e.g., zero to 0.5 standard deviations above the mean), the assessment module 220 may apply a classifier model, such as a decision tree or a random forest, to classify a given user into one the classes (e.g., a top quintile of an intelligence distribution for a set of persons).

In some implementations, the assessment module 220 may assess a probability of membership in a particular class for each person. For example, given a set of classes of cognitive abilities, the assessment module 220 may apply a logistic regression model to assess the probability of membership in a particular class (e.g., the probability that the person belongs to the top quintile of the intelligence distribution is 21%).

Alternatively or in addition, the second cognitive ability levels 222 may assign a particular numerical value to the cognitive ability levels of each of the second persons 116a-c. For example, the assessment module 220 may use linear regression to assess numerical values for the IQ of a person (e.g., an IQ of 113 or a particular numerical value for fluid intelligence or working memory).

In some implementations, the comparison module 216 may identify multiple models whose results are aggregated to generate cognitive ability levels. For example, in the case of dividing data for the features into ten partitions, the comparison module 216 may identify ten separate models (e.g., one for each partition). The models may be of the same type (e.g., neural network models) or of multiple types (e.g., neural network and support vector machine). The comparison module 216 then stores the relationships between the types of features and the cognitive ability levels, which is represented by the multiple models, in the storage device 210. When the assessment module 220 applies the multiple models to the second features to assess the second cognitive ability levels 222, the assessment system 200 may aggregate the results of the multiple models to generate the second cognitive ability levels 222.

The assessment module 220 may average the results or find the most frequently occurring result to generate the second cognitive ability levels 222. In the case of a classification of qualitative cognitive ability levels, the assessment module 222 may identify a class that occurs the most. For example, if results of first and second class models are “high intelligence” and a result of a third class model is “average intelligence,” then the assessment module 222 identifies “high intelligence” as the selected class. For regression of numerical cognitive ability levels, the assessment module 222 may calculate an average of the numerical cognitive ability levels from the models. For example, if the generated numerical cognitive ability levels include IQs of 120, 122 and 130, then the assessment module 222 may calculates the average as an IQ of 124. The assessment module 222 may factor in the weights identified by the comparison module 216 when selecting from and/or averaging the results of multiple models.

The assessment module 220 may then store the second cognitive ability levels 222 (e.g., in the storage device 210). The assessment module 220 may also provide the second cognitive ability levels 222 to another system, as the systems described with respect to FIG. 1.

FIG. 3 is flow chart that shows an example of a process 300 for assessing cognitive ability. The process 300 may be performed, for example, by a system such as the system 100 and/or the assessment system 200. For clarity of presentation, the description that follows uses the system 100 and the assessment system 200 as examples for describing the process 300. However, another system, or combination of systems, may be used to perform the process 300.

The process 300 begins, at box 302, with receiving first cognitive ability levels for first persons. The first cognitive ability levels represent assessments of the first persons within a model of cognitive abilities. For example, the intelligence module 204 may receive the intelligence answers 208 and identify the first cognitive ability levels for the first persons.

The process 300 includes, at box 304, receiving first user generated online data of the first persons. For example, the assessment system 200 may receive the first user generated online data 214 for the first persons 110a-c from the first server system 104a.

The process 300 includes, at box 306, extracting first values for one or more types of features from the first user generated online data. For example, the feature extraction module 212 may extract the features from the first user generated online data 214.

The process 300 includes, at box 308, comparing, by a processing device, the extracted first values to the received first cognitive ability levels to identify relationships between the types of features and the received first cognitive ability levels. For example, the comparison module 216 may compare the first features and the first cognitive ability levels to generate models and to select a model with the smallest error.

The process 300 includes, at box 310, storing the relationships between the types of features and the received first cognitive ability levels in a storage device. For example, the comparison module 216 may store the relationships, which may be represented by the selected model, in the storage device 210.

The process 300 includes, at box 312, receiving second user generated online data of second persons. For example, the assessment system 200 may receive the second user generated online data 218 for the second persons 116a-c from the second server system 104b.

The process 300 includes, at box 314, extracting second values for the types of features from the second user generated online data. For example, the feature extraction module 212 may extract the second features from the second user generated online data 218.

The process 300 includes, at box 316, applying the stored relationships to the second values to assess second cognitive ability levels of the second persons within the model of cognitive abilities. For example, the assessment module 220 may apply the relationships to the second features to assess the second cognitive ability levels 222 of the second persons 116a-c.

One or more of the first persons or the second persons may be users of social networking, blogging, Internet chat (e.g., Internet Relay Chat), or discussion board systems. One or more of the first user generated online data or the second user generated online data may be posts to the social networking, blogging, Internet chat, or discussion board systems.

The process 300 may include determining that a first set of the first persons is associated with a second set of the second persons. Applying the stored relationships may include applying a relationship among the stored relationships for the first set to the second set as a group. For example, the feature extraction module 212 may extract a discussion group identifiers for posts from the first persons 110a-c and the second persons 116a-c. The comparison module 216 may determine that the first persons have a similar cognitive ability level and that they belong to the same discussion group. The assessment module 220 may determine that the second persons also belong to the discussion group and accordingly assesses a same cognitive ability level for the group of second persons.

The process 300 may include receiving associations between one or more of the first persons and one or more organizations. Receiving the first cognitive ability levels may include identifying one or more of the first cognitive ability levels based on the associations. For example, the feature extraction module 212 may extract an organization membership status from the posts for the first persons, such as membership in a society for individuals with high IQs. The intelligence module 204 may assess an average or typical IQ for members of the society to the persons identified as members.

FIG. 4 is a schematic diagram that shows an example of a machine in the form of a computer system 400. The computer system 400 executes one or more sets of instructions 426 that cause the machine to perform any one or more of the methodologies discussed herein. The machine may operate in the capacity of a server or a client machine in client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions 426 to perform any one or more of the methodologies discussed herein.

The computer system 400 includes a processor 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage device 416, which communicate with each other via a bus 408.

The processor 402 represents one or more general-purpose processing devices such as a microprocessor, central processing unit, or the like. More particularly, the processor 402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 may also be one or more special-purpose processing devices such as an application specific integrated circuit (ASIC), a field programmable gate array (FPGA), a digital signal processor (DSP), network processor, or the like. The processor 402 is configured to execute instructions of the system 100 or the assessment system 200 for performing the operations and steps discussed herein.

The computer system 400 may further include a network interface device 422 that provides communication with other machines over a network 418, such as a local area network (LAN), an intranet, an extranet, or the Internet. The computer system 400 also may include a display device 410 (e.g., a liquid crystal display (LCD) or a cathode ray tube (CRT)), an alphanumeric input device 412 (e.g., a keyboard), a cursor control device 414 (e.g., a mouse), and a signal generation device 420 (e.g., a speaker).

The data storage device 416 may include a computer-readable storage medium 424 on which is stored the sets of instructions 426 of the system 100 or the assessment system 200 embodying any one or more of the methodologies or functions described herein. The sets of instructions 426 of the system 100 or the assessment system 200 may also reside, completely or at least partially, within the main memory 404 and/or within the processor 402 during execution thereof by the computer system 400, the main memory 404 and the processor 402 also constituting computer-readable storage media. The sets of instructions 426 may further be transmitted or received over the network 418 via the network interface device 422.

While the example of the computer-readable storage medium 424 is shown as a single medium, the term “computer-readable storage medium” can include a single medium or multiple media (e.g., a centralized or distributed database, and/or associated caches and servers) that store the sets of instructions 426. The term “computer-readable storage medium” can include any medium that is capable of storing, encoding or carrying a set of instructions for execution by the machine and that cause the machine to perform any one or more of the methodologies of the present disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, it is appreciated that throughout the description, discussions utilizing terms such as “identifying”, “providing”, “enabling”, “finding”, “selecting” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

It is to be understood that the above description is intended to be illustrative, and not restrictive. Other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
receiving first cognitive ability levels for first persons, wherein the first cognitive ability levels represent assessments of the first persons within a model of cognitive abilities;
receiving first user generated online data of the first persons;
extracting first values for one or more types of features from the first user generated online data;
comparing, by a processing device, the extracted first values to the received first cognitive ability levels to identify relationships between the types of features and the received first cognitive ability levels; and
storing the relationships between the types of features and the received first cognitive ability levels in a storage device.

2. The method of claim 1, further comprising:
receiving second user generated online data of second persons;
extracting second values for the types of features from the second user generated online data; and
applying the stored relationships to the second values to assess second cognitive ability levels of the second persons within the model of cognitive abilities.

3. The method of claim 2, wherein one or more of the first persons or the second persons are users of social networking, blogging, Internet chats, or discussion board systems, and wherein one or more of the first user generated online data or the second user generated online data are posts to the social networking, blogging, Internet chats, or discussion board systems.

4. The method of claim 2, further comprising determining that a first set of the first persons is associated with a second set of the second persons, and wherein applying the stored relationships comprises applying a relationship among the stored relationships for the first set to the second set as a group.

5. The method of claim 2, wherein the types of features comprise a measure of words used within multiple groups of words for each of the first persons and the second persons.

6. The method of claim 2, wherein the types of features comprise one or more of a measure of vocabulary size for each of the first persons and the second persons, or a measure of a comparison between the vocabulary size for each of the first persons and the second persons to an average vocabulary size of other persons.

7. The method of claim 2, wherein the types of features comprise one or more of a measure of words used from particular subject matter topics for each of the first persons and the second persons, or a measure of a range of subject matter topics for each of the first persons and the second persons.

8. The method of claim 2, wherein the types of features comprise a measure of uncommon words used that are also included in documents that are linked to by the first user generated online data or the second user generated online data.

9. The method of claim 2, wherein the first cognitive ability levels comprise results of an intelligence test, and wherein the method further comprises performing the intelligence test on one or more of the first persons to generate one or more of the first cognitive ability levels.

10. The method of claim 2, wherein the first cognitive ability levels comprise results of an intelligence test, and wherein receiving the first cognitive ability levels comprises receiving third user generated online data that comprises one or more of the first cognitive ability levels for one or more of the first persons.

11. The method of claim 2, further comprising receiving associations between one or more of the first persons and one or more organizations, and wherein receiving the first cognitive ability levels comprises identifying one or more of the first cognitive ability levels based on the associations.

12. A non-transitory computer-readable medium having instructions stored thereon, which when executed by a processing device, cause the processing device to perform operations comprising:
receiving first cognitive ability levels for first persons, wherein the first cognitive ability levels represent assessments of the first persons within a model of cognitive abilities;
receiving first user generated online data of the first persons;
extracting first values for one or more types of features from the first user generated online data;
comparing, by the processing device, the extracted first values to the received first cognitive ability levels to identify relationships between the types of features and the received first cognitive ability levels; and
storing the relationships between the types of features and the received first cognitive ability levels in a storage device.

13. The method of claim 12, wherein the operations further comprise:
receiving second user generated online data of second persons;
extracting second values for the types of features from the second user generated online data; and
applying the stored relationships to the second values to assess second cognitive ability levels of the second persons within the model of cognitive abilities.

14. The computer-readable medium of claim 13, wherein one or more of the first persons or the second persons are users of social networking, blogging, Internet chats, or discussion board systems, and wherein one or more of the first user generated online data or the second user generated online data are posts to the social networking, blogging, Internet chats, or discussion board systems.

15. The computer-readable medium of claim 13, wherein the operations further comprise determining that a first set of the first persons is associated with a second set of the second persons, and wherein applying the stored relationships comprises applying a relationship among the stored relationships for the first set to the second set as a group.

16. The computer-readable medium of claim 13, wherein the types of features comprise a measure of words used within multiple groups of words for each of the first persons and the second persons.

17. The computer-readable medium of claim 13, wherein the types of features comprise one or more of a measure of vocabulary size for each of the first persons and the second persons, or a measure of a comparison between the vocabulary size for each of the first persons and the second persons to an average vocabulary size of other persons.

18. The computer-readable medium of claim 13, wherein the types of features comprise one or more of a measure of words used from particular subject matter topics for each of the first persons and the second persons, or a measure of a range of subject matter topics for each of the first persons and the second persons.

19. The computer-readable medium of claim 13, wherein the types of features comprise a measure of uncommon words used that are also included in documents that are linked to by the first user generated online data or the second user generated online data.

20. The computer-readable medium of claim 13, wherein the first cognitive ability levels comprise results of an intelligence test, and wherein the operations further comprise performing the intelligence test on one or more of the first persons to generate one or more of the first cognitive ability levels.

21. The computer-readable medium of claim 13, wherein the first cognitive ability levels comprise results of an intelligence test, and wherein receiving the first cognitive ability levels comprises receiving third user generated online data that comprises one or more of the first cognitive ability levels for one or more of the first persons.

22. The computer-readable medium of claim 13, wherein the operations further comprise receiving associations between one or more of the first persons and one or more organizations, and wherein receiving the first cognitive ability levels comprises identifying one or more of the first cognitive ability levels based on the associations.

23. A system comprising:
one or more interfaces to receive first cognitive ability levels and first user generated online data for first persons, wherein the first cognitive ability levels represent assessments of the first persons within a model of cognitive abilities;
one or more processing devices to extract first values for one or more types of features from the first user generated online data, compare the extracted first values to the received first cognitive ability levels to identify relationships between the types of features and the received first cognitive ability levels; and
one or more storage devices to store the relationships between the types of features and the received first cognitive ability levels.

24. The system of claim 23, wherein the interfaces are further to receive second user generated online data of second persons, and wherein the processing devices are further to extract second values for the types of features from the second user generated online data and apply the stored relationships to the second values to assess second cognitive ability levels of the second persons within the model of cognitive abilities.

25. The system of claim 24, wherein one or more of the first persons or the second persons are users of social networking, blogging, Internet chats, or discussion board systems, and wherein one or more of the first user generated online data or the second user generated online data are posts to the social networking, blogging, Internet chats, or discussion board systems.

26. The system of claim 24, wherein the processing devices are further to determine that a first set of the first persons is associated with a second set of the second persons, and apply a relationship among the stored relationships for the first set to the second set as a group.

27. The system of claim 24, wherein the types of features comprise a measure of words used within multiple groups of words for each of the first persons and the second persons.

28. The system of claim 24, wherein the types of features comprise one or more of a measure of vocabulary size for each of the first persons and the second persons, or a measure of a comparison between the vocabulary size for each of the first persons and the second persons to an average vocabulary size of other persons.

29. The system of claim 24, wherein the types of features comprise one or more of a measure of words used from particular subject matter topics for each of the first persons and the second persons, or a measure of a range of subject matter topics for each of the first persons and the second persons.

30. The system of claim 24, wherein the types of features comprise a measure of uncommon words used that are also included in documents that are linked to by the first user generated online data or the second user generated online data.

31. The system of claim 24, wherein the first cognitive ability levels comprise results of an intelligence test, and wherein the processing devices are further to perform the intelligence test on one or more of the first persons to generate one or more of the first cognitive ability levels.

32. The system of claim 24, wherein the first cognitive ability levels comprise results of an intelligence test, and wherein the interfaces are further to receive third user generated online data that comprises one or more of the first cognitive ability levels for one or more of the first persons.

33. The system of claim 24, wherein the interfaces are further to receive associations between one or more of the first persons and one or more organizations, and wherein the processing devices are further to identify one or more of the first cognitive ability levels based on the associations.
